(19) United States
(12) Patent Application Publication
(10) Pub. No.: US 2026/0070253 A1
(43) Pub. Date: Mar. 12, 2026

(54) MACHINES AND METHODS FOR CUTTING PRODUCTS AND IMPELLERS THEREFOR

(71) Applicant: Urschel Laboratories, Inc., Chesterton, IN (US)

(72) Inventor: Daniel Wade King, Valparaiso, IN (US)

(21) Appl. No.: 19/321,251

(22) Filed: Sep. 7, 2025

Related U.S. Application Data
(60) Provisional application No. 63/691,761, filed on Sep. 6, 2024.

(51) Int. Cl. B26D 7/06; B26D 3/28; B26D 7/08

(52) U.S. Cl. CPC B26D 7/0691; B26D 7/08; B26D 3/28

(57) ABSTRACT

An impeller adapted for use with centrifugal-type slicing machines includes a base and a ring spaced in an axial direction of the impeller, and at least a first intermediate plate disposed between the base and ring to define first and second tier levels within the impeller. The impeller includes paddles disposed between the base and the ring. Each paddle has a radially outermost extremity adjacent an outer perimeter of the impeller, an oppositely-disposed radially innermost extremity, and a face therebetween. Each face defines non-parallel first and second face portions disposed, respectively at the radially outermost and innermost extremities. Pockets are defined within each of the first and second tier levels, each disposed between each adjacent pair of the paddles. The pockets have triangular shapes and are delimited in radial directions of the impeller by the second face portions of the paddles and the outer perimeter of the impeller.

### CROSS-REFERENCE TO RELATED APPLICATIONS

This patent application claims the benefit of U.S. Provisional Application No. 63/691,761 filed Sep. 6, 2024, the contents of which are incorporated herein by reference.

### BACKGROUND OF THE INVENTION

The present invention generally relates to methods and machines for cutting products. The invention particularly relates to impellers adapted to transport products to at least one knife that slices the products, and particularly adapted to transport and orient food products that are relatively small, as a nonlimiting example, an almond.

Various types of equipment are known for slicing, shredding and granulating food products, as nonlimiting examples, vegetables, fruits, dairy products, and meat products. Widely used machines for this purpose are commercially available from Urschel Laboratories, Inc., and include machines under the name Model CC7. The Model CC7 machines are centrifugal-type slicers capable of slicing a wide variety of products at high production capacities. The Model CC7 line of machines is particularly adapted to produce uniform slices, strip cuts, shreds, and granulations. Certain configurations and aspects of Model CC7 machines are represented in U.S. Pat. Nos. 11,897,158, 12,083,669, 12,097,634, 12,128,579, and 12,220,831, the entire contents of which are incorporated herein by reference.

FIG. 1 schematically represents a cross-sectional view of a machine 10 that is representative of a Model CC7 machine. The machine 10 includes a generally annular-shaped cutting head 12 and an impeller 14 coaxially mounted within the cutting head 12. The impeller 14 has an axis 17 of rotation that coincides with the center axis of the cutting head 12, and is rotationally driven about its axis 17 through a shaft (not shown) that is enclosed within a housing 18 and coupled to a gear box 16. The cutting head 12 is mounted on a support ring 15 above the gear box 16 and remains stationary as the impeller 14 rotates. Products are delivered to the cutting head 12 and impeller 14 through a feed hopper 11 located above the impeller 14. In operation, as the hopper 11 delivers products to the rotating impeller 14, centrifugal forces induced by the rotation of the impeller 14 cause the products to move outward into engagement with cutting knives (not shown) that are mounted along the circumference of the cutting head 12. The impeller 14 comprises generally radially oriented paddles 13, each having a face that engages and directs the products radially outward toward and against the knives of the cutting head 12 as the impeller 14 rotates. Other aspects pertaining to the construction and operation of Model CC7 machines, including various embodiments thereof, can be appreciated from the aforementioned prior patent documents incorporated herein by reference.

FIG. 2 is an isolated view of a particular but nonlimiting example of a cutting head 12 that has been used with centrifugal-type slicing machines, including the Model CC7 slicing machine 10 schematically represented in FIG. 1. The cutting head 12 represented in FIG. 2 will be described hereinafter in reference to the machine 10 of FIG. 1 equipped with an impeller, including but not limited to the impeller 14 of FIG. 1. On the basis of the coaxial arrangement of the cutting head 12 and the impeller 14, relative terms including but not limited to Aaxial,@ Acircumferential,@ Aradial,@ etc., and related forms thereof may be used below to describe the cutting head 12 represented in FIG. 2.

In FIG. 2, the cutting head 12 can be seen as generally annular-shaped with cutting knives 20 mounted and circumferentially spaced apart along its perimeter. FIG. 2 represents the knives 20 as having straight cutting edges for producing flat slices, and as such may be referred to herein as Aflat@ knives, though the cutting head 12 can use knives of other shapes, for example, Acorrugated@ knives characterized by a periodic pattern, including but not limited to a sinusoidal shape with peaks and valleys when viewed edgewise, to produce corrugated, strip-cut, shredded and granulated products. Each knife 20 projects radially inward in a direction generally opposite the direction of rotation of the impeller 14 within the cutting head 12, and defines a cutting edge at its innermost radial extremity. The cutting head 12 further comprises lower and upper support members, represented in FIG. 2 as rings 22 and ring 24, to and between which circumferentially-spaced support segments, referred to herein as shoes 26, are secured with fasteners 34.

As also represented in FIG. 2, a knife 20 can be associated with each shoe 26, in which case the shoes 26 may be referred to as cutting stations of the cutting head 12. The knives 20 of the cutting head 12 are represented in FIG. 2 as being individually secured with clamping assemblies 28 to their respective shoes 26. Each clamping assembly 28 includes a knife holder 30 mounted between the support rings 22 and 24, and a clamp 32 positioned on the radially outward-facing side of the holder 30 to secure a knife 20 thereto. Each knife 20 is supported by a radially outer surface of one of the knife holders 30, and the corresponding clamp 32 overlies the holder 30 so that the knife 20 is between the outer surface of the holder 30 and a radially inward surface of the clamp 32 that faces the holder 30. By forcing the clamp 32 toward the holder 30, the clamp 32 applies a clamping force to the knife 20 adjacent its cutting edge. FIG. 2 further shows a gate 36 secured to each shoe 26. A food product crosses the gate 36 prior to encountering the knife 20 mounted to the succeeding shoe 26, and together the cutting edge of a knife 20 and a trailing edge of the preceding gate 36 define a gate opening that determines the thickness of a slice produced by the knife 20.

FIGS. 3 and 4 are isolated perspective and top views, respectively, of a particular impeller 40 disclosed in U.S. Pat. No. 10,456,943. The impeller 40 is configured for rotation, for example, within a cutting head such as the cutting head 12 of FIG. 2, as well as other configurations of cutting heads having an annular shape within which the impeller 40 can be installed for rotation, as discussed above in reference to FIGS. 1 and 2. As such, the impeller 40 is also capable of use with centrifugal-type slicing machines, including the Model CC7 slicing machine 10 schematically represented in FIG. 1. The impeller 40 will be described below in reference to the cutting head 12 of FIG. 2, though it should be understood that the impeller 40 can find suitable use in cutting heads other than what is shown in FIG. 2. On the basis of the coaxial arrangement of the impeller 40 with the cutting head 12, relative terms including but not limited to Aaxial,@ Acircumferential,@ Aradial,@ etc., and related forms thereof may be used below to describe the impeller 40 represented in FIGS. 3 and 4.

Similar to the impeller 14 of FIG. 1, the impeller 40 is shown in FIGS. 3 and 4 as comprising generally radially-oriented paddles 42 disposed between a base 44 and an upper ring 46 (not shown in FIG. 4 to reveal the interior of the impeller 40). A frustoconical-shaped flange 48 extends in a generally axial direction from the ring 46 to define an entrance or opening through which products enter the impeller 40. Each paddle 42 has a radially outermost extremity adjacent and preferably contiguous with the outer perimeter of the impeller 40, an oppositely-disposed radially innermost extremity, and a face 52 between the radially innermost and outermost extremities and facing the rotational direction of the impeller 40. The faces 52 of the paddles 42 define surfaces that engage and direct the products radially outward toward and against the cutting head 12 surrounding the impeller 40 as the impeller 40 rotates, and in particular to encounter the knives 20 of the cutting head 12 where the products undergo a slicing operation.

FIGS. 3 and 4 depict the impeller 40 as comprising intermediate plates 60 that are disposed between the base 44 and ring 46. In combination with the base 44 and ring 46, the plates 60 define tier levels within the impeller 40, each capable of receiving products. The plates 60 are represented as being oriented to be substantially parallel to each other and to the base 44 and ring 46. FIG. 4 depicts the impeller 40 with the ring 46 removed to reveal the plates 60 as having openings 66 of decreasing size towards the base 44, such that a fraction of the products that enter the impeller 40 through its opening will be captured within each of the tier levels defined by and between the base 44, plates 60, and ring 46. In this manner, the plates 60 serve to axially (vertically) stratify the distribution of products within the impeller 40.

FIGS. 3 and 4 further show the impeller 40 equipped with pockets 68 (FIG. 4) defined at each paddle 42 within each tier level, with each pocket 68 being disposed between a pair of paddles 42 that are immediately adjacent each other in the direction of rotation of the impeller 40. Each pocket 68 is also delimited in the axial direction of the impeller 40 by two of the base 44, ring 46, and plates 60. Attachments 72 extend from the face 52 and radially innermost extent of each paddle 42 to further delimit each pocket 68 in the radial direction of the impeller 40 and form restricted openings 74 to the pockets 68 in the circumferential direction of the impeller 40. The intended purpose of the delimited pockets 68 and their restricted openings 74 is to promote the ability of the impeller 40 to deliver relatively small elongate products (for example, almonds, coffee beans, etc.) to the cutting head knives 20 so that the major dimension of each product has a particular orientation to the cutting head 12, preferably so that the major axis of each product is oriented to be functionally tangent to the outer diameter of the impeller 40. In this manner, a majority of the cuts through the products are lengthwise and nearly parallel to their major axes.

While impellers of the type represented in FIGS. 3 and 4 have performed extremely well for their intended purpose, further improvements are continuously desired and sought for centrifugal-type slicing machines, including the Model CC7.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides impellers of types suitable for use with centrifugal-type slicing machines for cutting products.

According to an aspect of the invention, an impeller adapted to be coaxially mounted within an annular-shaped cutting head for rotation about a rotational axis thereof in a rotational direction relative to the cutting head. The impeller includes a base and a ring spaced from each other in an axial direction of the impeller. The ring defines an entrance to the impeller. At least a first intermediate plate is disposed between the base and the ring so as to define at least first and second tier levels within the impeller. The first tier level is between the ring and the first intermediate plate, and the second tier level is between the first intermediate plate and the base. The first intermediate plate has an opening therein that defines a passage between the first and second tier levels. The impeller further includes paddles disposed between the base and the ring. At least a portion of each paddle is disposed within at least one of the first and second tier levels. Each paddle has a radially outermost extremity adjacent an outer perimeter of the impeller, an oppositely-disposed radially innermost extremity, and a face between the radially innermost and outermost extremities and facing the rotational direction of the impeller. Each face defines non-parallel first and second face portions that lie between the radially innermost and outermost extremities of the paddles. The first face portions are disposed at the radially outermost extremities of the paddles so as to be adjacent the outer perimeter of the impeller and the second face portions are disposed at the radially innermost extremities of the paddles so as to be spaced a radially inward distance from the outer perimeter of the impeller. Pockets are defined within each of the first and second tier levels, each pocket being disposed between a pair of the paddles that are immediately adjacent each other in the rotational direction of the impeller. The pockets have triangular shapes and are delimited in radial directions of the impeller by the second face portions of the paddles and the outer perimeter of the impeller.

Other nonlimiting aspects of the invention include machines in which an impeller as described above is installed, and methods of using impellers as described above.

Technical effects of impellers as described above include the capability of promoting the delivery of relatively small elongate products to knives so that the major dimension of each product is oriented to be functionally tangent to the outer diameter of the impeller, thereby promoting a majority of cuts through the products to be lengthwise and nearly parallel to the major axes of the products.

Other aspects and advantages of this invention will be appreciated from the following detailed description.

### BRIEF DESCRIPTION OF THE DRAWINGS

FIG. 1 schematically represents a side view in partial cross-section of a centrifugal-type slicing machine known in the art.

FIG. 2 is a perspective view representing details of a cutting head that has found use in slicing machines of the type represented in FIG. 1.

FIG. 3 is a perspective view representing an impeller that has found use in slicing machines of the type represented in FIG. 1.

FIG. 4 is a plan view of the impeller of FIG. 3 with a top ring removed to reveal the interior of the impeller.

FIG. 5 is a perspective view representing an impeller in accordance with a nonlimiting embodiment of the invention and suitable for use with the slicing machine of FIG. 1 and/or the cutting head of FIG. 2.

FIG. 6 is a plan view of the impeller of FIG. 5 with a top ring removed to reveal the interior of the impeller.

FIG. 7 is a plan view representing details of the impeller of FIGS. 5 and 6.

FIG. 8 is an isolated perspective view of a paddle of the impeller of FIGS. 5 and 6.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular depicted embodiment could be eliminated, and also encompasses additional or alternative embodiments that combine two or more features or aspects shown and/or described as part of different depicted embodiments. Therefore, the appended claims, and not the detailed description, are intended to particularly point out subject matter regarded to be aspects of the invention, including certain but not necessarily all of the aspects and alternatives described in the detailed description.

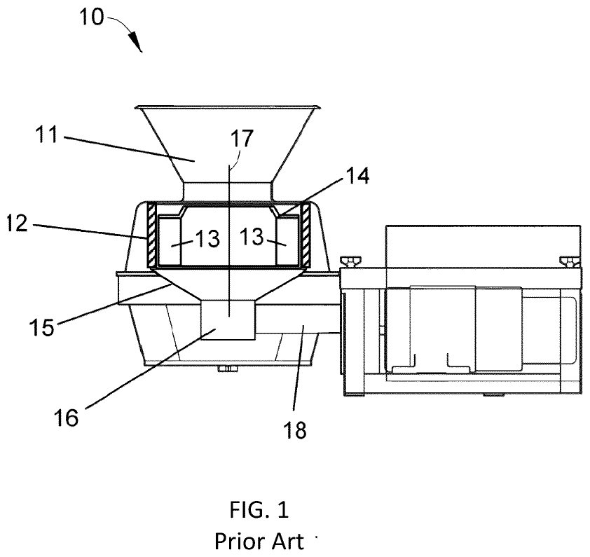

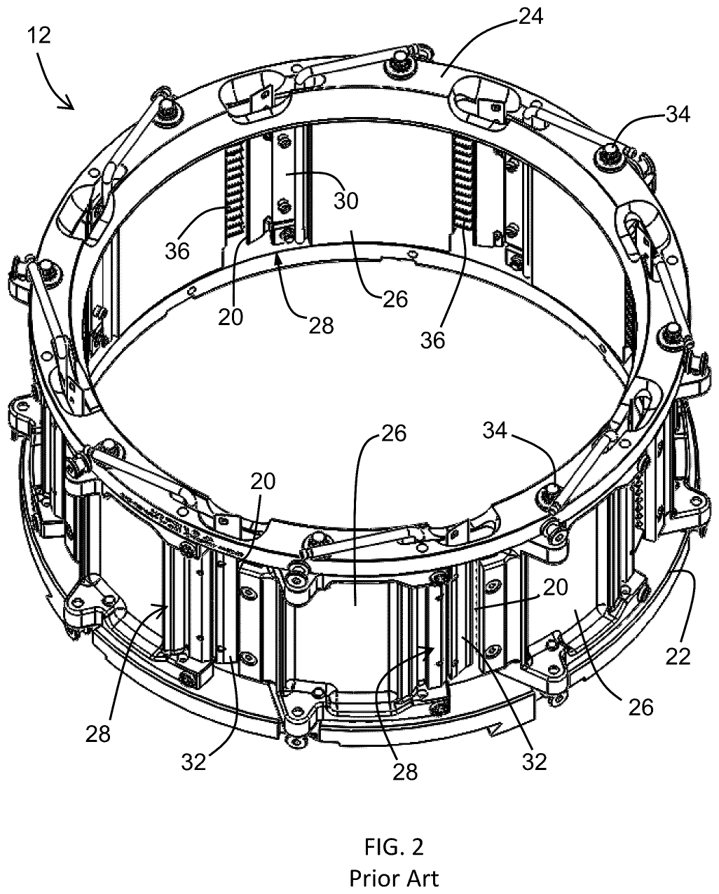

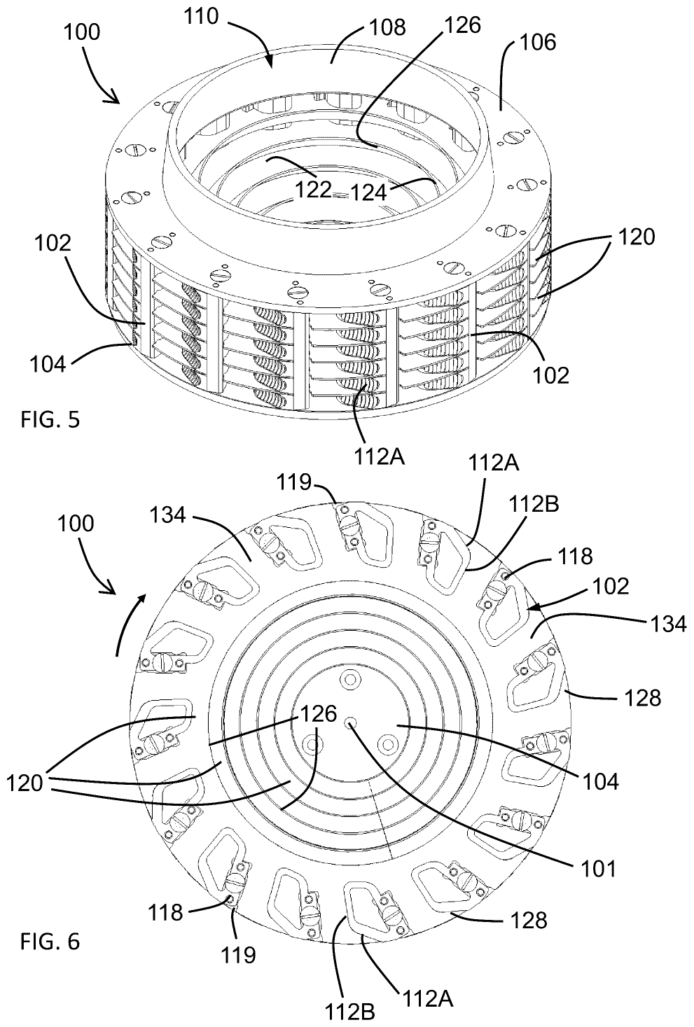

FIGS. 5 through 8 schematically represent nonlimiting embodiments of an impeller 100 and components thereof that are capable of use with a variety of cutting machines, including the centrifugal-type slicing machine 10 depicted in FIG. 1 and/or the cutting head of FIG. 2. In some instances, the impeller 100 may serve as a replacement for use with machines and cutting heads of the types represented in FIGS. 1 and 2. As a matter of convenience, the impeller 100 will be illustrated and described hereinafter in reference to the slicing machine 10 of FIG. 1 equipped with the annular-shaped cutting head 12 as described in reference to FIGS. 1 and 2. As such, the following discussion will focus primarily on certain aspects of the illustrated impeller 100 in reference to certain aspects of the machine 10 and cutting head 12 represented in FIGS. 1 and 2, whereas other aspects of the impeller 100, machine 10, and cutting head 12 not discussed in any detail below may be essentially as was described in reference to FIGS. 1 and 2. However, it will be appreciated that the teachings of the invention may also be generally applicable to other types of cutting machines. Moreover, though such machines and cutting heads are particularly well suited for slicing food products, it is within the scope of the invention that knife assemblies described herein could be utilized in machines and cutting heads adapted to cut a wide variety of other types of materials.

To facilitate the description provided below of the impeller 100 represented in the drawings, relative terms may be used in reference to the orientation of the impeller 100 within the cutting head 12 of FIG. 2, as represented by the cutting head 12 and impeller 14 of the machine 10 in FIG. 1. On the basis of the coaxial arrangement of the cutting head 12 and impeller 14 shown in FIG. 1, relative terms including but not limited to Aaxial,@ Acircumferential,@ Aradial,@ etc., and related forms thereof may also be used below to describe the impeller 100 represented in the drawings. All such relative terms are useful to describe the impeller 100 depicted in FIGS. 5 through 8 but should not be otherwise interpreted as limiting the scope of the invention. Furthermore, as used herein, “leading” (and related forms thereof) refers to a position on the impeller 100 that is ahead of or precedes another in the direction of rotation of the impeller 100 when assembled with and rotating within the cutting head 12, whereas “trailing” (and related forms thereof) refers to a position on the impeller 100 that follows or succeeds another relative to the direction of the impeller's rotation.

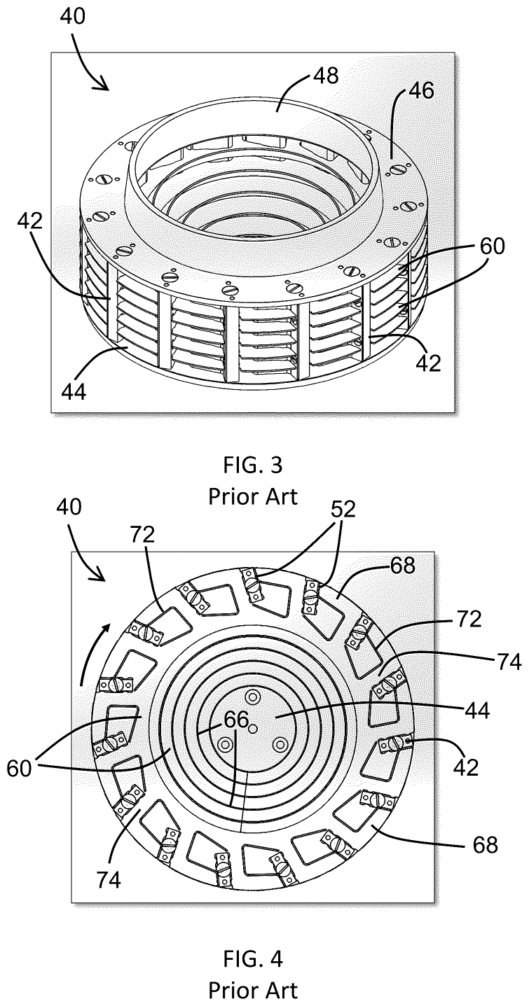

Similar to the impeller 40 of FIGS. 3 and 4, the impeller 100 is shown in FIGS. 5 and 6 as comprising generally radially-oriented paddles 102 disposed between a base 104 and an upper ring 106 (not shown in FIG. 6 to reveal the interior of the impeller 100). The base 104 and ring 106 are represented in the embodiment of FIG. 5 as being parallel to each other and perpendicular to the axis 101 of rotation of the impeller 100. A frustoconical-shaped flange 108 extends in a generally axial direction from the ring 106 to define an entrance or opening 110 through which products enter the impeller 100.

Also generally similar to the impeller 40 of FIGS. 3 and 4, the impeller 100 is shown in FIGS. 5 and 6 as comprising intermediate plates 120 that are disposed between the base 104 and ring 106. In combination with the base 104 and ring 106, the plates 120 define six tier levels between the base 104 and ring 106 within the impeller 100, each capable of receiving products. The plates 120 are represented as being oriented to be substantially parallel to each other and to the base 104 and ring 106, and therefore also perpendicular to the axis 101 of the impeller 100. Though five plates 120 are represented within the impeller 100, fewer or more than five plates could be utilized.

In the embodiment of FIGS. 5 and 6, each plate 120 has a generally annular shape that defines an opening 126 that is generally concentric with the axis 101 of the impeller 100. The plates 120 are represented as including a substantially planar portion 122 surrounding a frustoconical flange 124 that is located at the radially innermost edge of each plate 120 and extends in a generally axial direction from the planar portion 122. As evident from FIG. 6, the openings 126 in the plates 120 are successively smaller in diameter toward the base 120 and define passages between the tiers through which products are able to pass to enter one of the lower tier levels, such that the plates 120 include the ability to function as baffles. For example, a fraction of the products that enters the impeller 100 through its opening 110 (FIG. 5) will be captured within the uppermost tier level defined between the uppermost plate 60 and the ring 106 as a result of encountering and being deflected by the planar portion 122 or flange 124 of the uppermost plate 120, whereas another fraction of the products that enter the impeller 100 will pass through the opening 126 in the uppermost plate 120 but then be captured within one of the lower tier levels defined by or between the plates 120 beneath the uppermost plate 120 as a result of encountering and being deflected by the planar portion 122 or flange 124 of a lower plate 120, whose opening 126 is smaller than the opening 126 in the uppermost plate 120. The remaining portions of the products that are not captured with one of the plates 120 will pass through the opening 126 of the lowermost plate 120 and enter the lowermost tier level defined by and between the base 104 and the lowermost plate 120.

In view of the above, the plates 120 serve to axially (vertically) stratify the distribution of products within the impeller 100, with the result that a greater portion of the length of each cutting head knife 20 will be used to slice the products than would otherwise likely occur. It should be appreciated that the size and number of paddles 102 and plates 120 can be varied to influence the stratification and distribution of products within the impeller 100. In addition, the axial distances between the base 104, ring 106, and plates 120 can be tailored to influence the stratification and distribution of products within the impeller 100. For example, it may be determined that increasingly greater or smaller axial spacings are desired between the base 104, plates 120, and ring 106 in order to promote a uniform or otherwise desired distribution among the tiers.

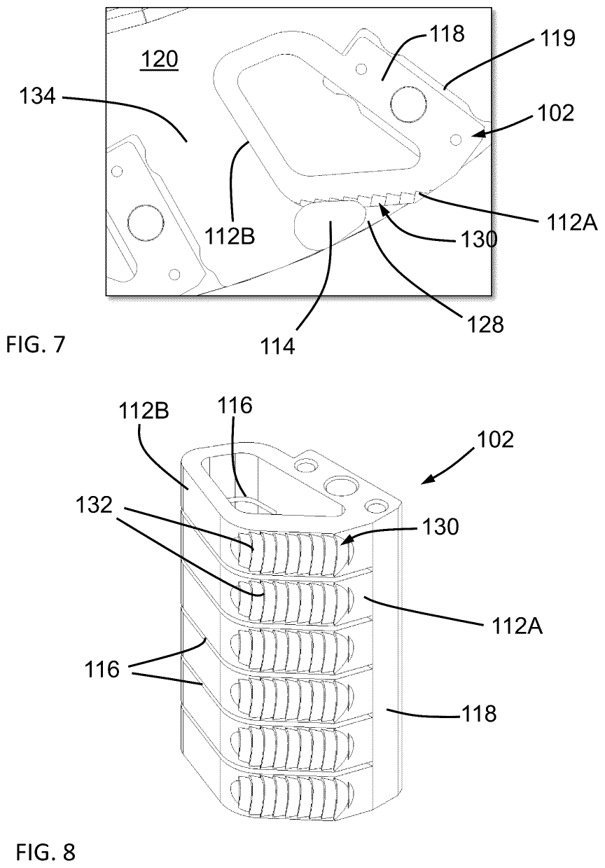

In the nonlimiting embodiment of FIGS. 5 and 6, the paddles 102 are equi-angularly spaced at the outer perimeter of the impeller 100. Each paddle 102 is preferably a unitary component as represented in FIG. 8 and is assembled to be continuous between the base 104 and ring 106 and therefore passes through the plates 120. For this purpose, the paddle 102 is represented in FIG. 8 as having slots 116 sized to receive edges of the plates 120. For example, each plate 120 can be configured with slots 119 (FIGS. 6 and 7) that are contiguous with the perimeter of the plate 120 and sized to receive a base portion 118 of each paddle 102, enabling the paddles 102 to be inserted into the impeller 100 from the perimeter of the impeller 100, as well as removed from the impeller 100 for cleaning, repair, or replacement. Alternatively, each paddle 102 could be made up of multiple paddles, each individually and entirely disposed within a single tier level of the impeller 100. In either case, the impeller 100 is an assembly constructed of individually formed paddles 102 mounted and secured between the base 104 and ring 106. In the embodiment shown in FIGS. 5 and 6, each paddle 102 is individually mounted to the base 104 and ring 106 with bolts and pins that are received in corresponding holes formed in the base 104 and ring 106. As a result of its modular construction, the impeller 100 and its components can be formed by casting as well as other processes, and formed of various materials in addition to commonly-used MAB (manganese aluminum bronze) alloys.

Each paddle 102 has a radially outermost extremity that is adjacent and preferably contiguous with the outer perimeter of the impeller 100, an oppositely-disposed radially innermost extremity, and a face having two non-parallel face portions 112A and 112B that lie between the radially innermost and outermost extremities of the paddles 102 and face the rotational direction (FIG. 6) of the impeller 100. Each face portion 112A is disposed at the radially outermost extremity of its paddle 102 so as to be adjacent and preferably contiguous with the outer perimeter of the impeller 100, and each face portion 112B is disposed at the oppositely-disposed radially innermost extremity of its paddle 102 so as to be spaced a radially inward distance from the outer perimeter of the impeller 100. The face portions 112A and 112B define surfaces of the paddles 102 that engage and direct products 114 (FIG. 7) within the impeller 100 in radially outward directions toward and against the cutting head 12 surrounding the impeller 100 as the impeller 100 rotates, such that the products 144 will encounter the knives 20 of the cutting head 12 where the products 114 undergo a slicing operation. FIGS. 5 through 8 show the face portions 112A and 112B of each paddle 102 as defining planar surfaces, though other surface configurations are possible. The pitch of each paddle face 112A and 112B is shown in FIG. 6 as being positive, meaning that the radially innermost extremity of each paddle face 112A and 112B is angled opposite the direction of rotation of the impeller 100 relative to a radial of the impeller 100. Alternatively, the pitch of the paddle faces 112B could be negative or neutral (meaning that the face 112B entirely lies on a radial of the impeller 100).

The pitch of each paddle face 112A is represented in FIGS. 5 through 8 as positive such that the paddles 102 define pockets 128 within each tier level, with each pocket 128 being disposed between a pair of paddles 102 that are immediately adjacent each other in the direction of rotation of the impeller 100. As represented in FIG. 6, each pocket 128 is disposed contiguous with the outer perimeter of the impeller 100 and delimited in the radial direction of the impeller 100 by the perimeter of the impeller 100 and the face portion 112A of its corresponding paddle 102. The paddles 102 differ in construction and configuration from the paddles 42 of FIGS. 3 and 4 in part as a result of their face portions 112A defining the pockets 128 to have a generally triangular shape, as evident in FIGS. 6 and 7. Furthermore, the face portion 112A defining the pocket 128 is formed to have a semi-circular recess 130 that defines a portion of the pocket 128 associated with its face portion 112A. The semi-circular recesses 130 are represented as having surfaces that are equipped with rows of teeth 132 to inhibit rotation of products 114 captured in their respective pockets 128. The teeth 132 are represented in FIGS. 5, 7, and 8 as being oriented vertically (axially), though it is foreseeable that other orientations may be possible and yet inhibit rotation of products 114 captured in the pocket 128.

The triangular-shaped pockets 128 represented in FIGS. 5 through 8 have been shown through testing to be particularly advantageous when processing relatively small food products, nonlimiting examples of which include almonds, coffee beans, strawberries, mushrooms, etc., as these products are prone to rotation during slicing. Further, the greater stratification achieved with the impeller 100 enables these smaller products to encounter a greater portion of the length of each knife 20 in the axial direction of the cutting head 12 (as viewed in FIG. 2). The size of the impeller 100 can also be tailored for processing different sized products, such that the size and/or shape of the pockets 128 can be tailored to receive and orient a particular product of a particular size during the process of being sequentially cut by the circumferential series of knives 20 mounted to the cutting head 12 in which the impeller 100 is installed and rotating.

FIGS. 5 and 6 further show the paddles 102, and particularly the face portions 112B of the paddles 102, as forming a restricted passage 134 to the pocket 128 at the radially innermost extremities of an adjacent pair of paddles 102. The passages 134 are restricted in the sense that each has a circumferential extent (i.e., its width in the direction of rotation of the impeller 100) that is narrower than the distance between the radially outermost extremities of an adjacent pair of paddles 102. The intended purpose of the restricted passage 134 is to regulate the flow of relatively small elongate products 114 (for example, almonds, coffee beans, etc.) to the pockets 128 and promote the ability of the impeller 100 to deliver such products 114 so that the major axis of each product is oriented so that a majority of the cuts through the products 114 are lengthwise and nearly parallel to their major axes. The face portions 112B of the paddles 102 shown in FIGS. 6 and 7 are represented as reducing the entrances to the pockets 128 by roughly fifty percent, though lesser and greater restrictions are foreseeable.

The face portions 112B of the paddles 102 are depicted as defining planar surfaces, such that the face portions 112B present a flat or blunt surface to products 114 entering the pockets 128. Each restricted passage 134 is defined by and between the planar surface of a face portion 112B and a preceding paddle 102 in the rotational direction. The planar surface of each face portion 112B is further represented as being roughly parallel to a rear face of the preceding paddle 102, such that the resulting restricted passage 134 has a generally uniform width along its radial extent in a radial direction of the impeller 100, which may assist with orienting elongated products. The planar surfaces of the face portions 112B may also reduce the risk of damage to the products, and may be used as an attachment point for a flexible component to further reduce impact damage.

The surface conditions of the base 104 and plates 120 may affect the manner and speed with which products 114 are transferred to the pockets 128 and stabilized within the pockets 128. For example, the surfaces of the base 104 and plates 120 facing the opening 110 of the impeller 100 may be blast finished, polished, and/or grooved for this purpose to promote a desired effect. The manner and speed with which products 114 can be transferred to the pockets 128 and stabilized within the pockets 128 may be promoted by ensuring that at least the planar portions 122 of the plates 120 are parallel to the base 104 and/or perpendicular to the axis 101 of the impeller 100.

As previously noted above, though the foregoing detailed description describes certain aspects of one or more particular embodiments of the invention, alternatives could be adopted by one skilled in the art. For example, the impeller 100 and a cutting head and machine in which it is installed could differ in appearance and construction from what is shown in the drawings, the functions of each component of the impeller 100 could be performed by components of different construction but capable of a similar (though not necessarily equivalent) function, and various materials and processes could be used to fabricate the impeller 100 and its components. In addition, it is foreseeable that the impeller 100 could be used in combination with a cutting head adapted for cutting materials other than almonds or other food products. As such, and again as was previously noted, it should be understood that the invention is not necessarily limited to any particular embodiment described herein or illustrated in the drawings.

1. An impeller adapted to be coaxially mounted within an annular-shaped cutting head for rotation about a rotational axis thereof in a rotational direction relative to the cutting head, the impeller comprising:
a base and a ring spaced from each other in an axial direction of the impeller, the ring defining an entrance to the impeller;
at least a first intermediate plate disposed between the base and the ring so as to define at least first and second tier levels within the impeller, the first tier level being between the ring and the first intermediate plate, the second tier level being between the first intermediate plate and the base, the first intermediate plate having an opening therein that defines a passage between the first and second tier levels;
paddles disposed between the base and the ring, at least a portion of each paddle being disposed within at least one of the first and second tier levels, each of the paddles having a radially outermost extremity adjacent an outer perimeter of the impeller, an oppositely-disposed radially innermost extremity, and a face between the radially innermost and outermost extremities and facing the rotational direction of the impeller, the face defining non-parallel first and second face portions that lie between the radially innermost and outermost extremities of the paddles, the first face portions being disposed at the radially outermost extremities of the paddles so as to be adjacent the outer perimeter of the impeller and the second face portions being disposed at the radially innermost extremities of the paddles so as to be spaced a radially inward distance from the outer perimeter of the impeller; and
pockets defined within each of the first and second tier levels, each pocket being disposed between a pair of the paddles that are immediately adjacent each other in the rotational direction of the impeller, the pockets having triangular shapes and being delimited in radial directions of the impeller by the second face portions of the paddles and the outer perimeter of the impeller.

2. The impeller of claim 1, further comprising a semi-circular recess defined in each of the first face portion such that the semi-circular recesses define portions of the pockets.

3. The impeller of claim 2, wherein the semi-circular recesses have surfaces equipped with rows of teeth to inhibit rotation of products captured in the pockets.

4. The impeller of claim 3, wherein the teeth are oriented in the axial direction of the impeller.

5. The impeller of claim 1, wherein each of the paddles is continuous between the base and the ring and has a slot that receives an edge portion of the first intermediate plate.

6. The impeller of claim 1, wherein the first intermediate plate has slots that are contiguous with an outer perimeter of the first intermediate plate and sized to receive a base portion of each of the paddles.

7. The impeller of claim 1, wherein the paddles are insertable into the impeller from the outer perimeter of the impeller.

8. The impeller of claim 1, wherein the first intermediate plate has a generally annular shape that includes a planar portion that surrounds the opening in the first intermediate plate.

9. The impeller of claim 8, wherein the planar portion of the first intermediate plate surrounds a frustoconical flange that extends in the axial direction from the planar portion and defines the opening in the first intermediate plate.

10. The impeller of claim 1, wherein the opening in the first intermediate plate is concentric with the rotational axis of the impeller.

11. The impeller of claim 1, further comprising at least a second intermediate plate disposed between the first intermediate plate and the base so as to define at least a third tier level within the impeller between the second intermediate plate and the base, the second intermediate plate having an opening therein that defines a portion of a passage between the second and third tier levels.

12. The impeller of claim 11, wherein the openings in the first and second intermediate plates are concentric with the rotational axis of the impeller.

13. The impeller of claim 11, wherein the opening in the second intermediate plate is smaller than the opening in the first intermediate plate.

14. The impeller of claim 1, wherein the paddles are equi-angularly spaced at the outer perimeter of the impeller and the pockets are identical.

15. The impeller of claim 1, wherein the second face portions disposed at the radially innermost extremities of the paddles form restricted openings to one of the pockets that is narrower than a distance between the radially outermost extremities of adjacent pairs of the paddles.

16. The impeller of claim 15, wherein each of the second face portions defines a planar surface and each of the restricted openings is defined by and between one of the planar surfaces and a rear face of a preceding one of the paddles in the rotational direction.

17. The impeller of claim 16, wherein each of the planar surfaces is parallel to the rear face of a preceding one of the paddles in the rotational direction and the restricted opening defined thereby has a generally uniform width in one of the radial directions of the impeller.

18. A machine comprising the impeller of claim 1, the machine comprising an annular-shaped cutting head having at least one knife extending radially inward toward the impeller in a direction opposite the rotational direction of the impeller.

19. A method of using the impeller of claim 1, the method comprising:
rotating the impeller;
supplying products to the impeller through the entrance defined by the ring;
stratifying the products among the first and second tier levels with the first intermediate plate and the opening therein; and
propelling the products into the pockets through action of rotating the impeller.

20. The method of claim 19, further comprising orienting the products within the pockets to have a major axis functionally tangent to the outer perimeter of the impeller.
